(19) United States
(12) Patent Application Publication
(10) Pub. No.: US 2006/0167208 A1
(43) Pub. Date: Jul. 27, 2006

(54) Urethane acrylate gel coat resin and method of making

(75) Inventors: Archie W. Garner, Ham lake, MN (US); Brain A. Robertson, Long Sault (CA); Thomas J. Melnyk, Greenfield, MN (US); Ehtisham A. Ashai, Carson, CA (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: VALSPAR SOURCING, INC., Minneapolis, MN (US)

(21) Appl. No.: 10/521,225

(22) PCT Filed: Jul. 21, 2003
(86) PCT No.: PCT/US03/22722

§ 371 Date: Jul. 6, 2005

Related U.S. Application Data
(60) Provisional application No. 60/402,657, filed on Aug. 12, 2002.
(60) Provisional application No. 60/431,811, filed on Dec. 9, 2002.

(51) Int. Cl. C08G 18/34

(52) U.S. Cl. 528/84

(57) ABSTRACT

An improved urethane acrylate gel coat resin, its method of manufacture, and its use in gel coat compositions are disclosed. The urethane acrylate gel coat resin contains terminal acrylate moieties and is the reaction product of an oligoester of weight average molecular weight about 200 to about 4000, a diisocyanate, and a hydroxyalkyl (meth)acrylate. The gel coat resin is used in gel coat compositions that exhibit good weatherability and color stability after cure.

### FIELD OF THE INVENTION

The present invention relates to improved resins for use in gel coat compositions.

### BACKGROUND OF THE INVENTION

Coated, molded articles, often fiber-reinforced, typically are made by spreading a “gel coat composition” over the surface of a mold having a surface corresponding to the article in negative relief. Consequently, the gel coat composition, after cure, becomes the outermost layer of the molded article that is exposed to the environment. The gel coat composition is spread across the surface of the mold by any one of a number of conventional techniques, e.g., brushing, hand lay-up, or spraying, and usually as a relatively thick layer, e.g., 0.5 to 0.8 mm, to maximize its weather and wear resistance, and if the molded article is fiber-reinforced, to help mask the fiber reinforcement pattern which can show through the gel coat due to inherent resin shrinkage that occurs around the fibers during cure.

A gel coat is a prepromoted resin, typically a polyester, and typically is pigmented. After the gel coat is applied to the surface of the mold, it is at least partially cured. A plastic, optionally fiber-reinforced, then is applied to the partially or fully cured gel coat by any one of a number of conventional techniques, and the resulting laminate structure cured. The cure can be promoted through the use of free radical polymerization processes.

In addition to imparting weather and wear resistance to the molded article, the gel coat also imparts cosmetic properties to the article. In many applications, particularly consumer applications such as automobile parts, shower stalls, bathtub enclosures, and appliances, a high initial gloss and extended gloss retention are very desirable or necessary properties for the molded article. Present-day gel coats often exhibit a high gloss upon cure, but lose this gloss over time due to a variety of environmental factors, such as sunlight, heat, cold, water, and corrosive chemicals, long before the end of the useful life of the article. Moreover, loss of gloss is often accompanied by the appearance of surface defects, such as cracks, coarseness, and blisters, and these often are indicative of structural deterioration of the molded article itself.

The use of unsaturated polyesters in ad-mixture with unsaturated aromatic monomers, such as styrene, in gel coat compositions is well known in the art. The unsaturated polyesters are prepared from the condensation of unsaturated acids or acid anhydrides with polyols. A common unsaturated acid is either maleic anhydride or fumaric acid. While not intending to be bound by theory, it is believed that ester linkages formed from these ingredients exhibit poor hydrolysis resistance, and consequently the overall film performance of a coating film based on these polymers is relatively poor. Aromatic di-acids, such as isophthalic acid, have been used to help improve the hydrolysis resistance of the film. However, the presence of aromatic nuclei reduces the exterior durability of the coating film.

One high quality gel coat is an isophthalic acid/neopentyl glycol (IPA/NPG)-based unsaturated polyester diluted in styrene monomer. However, the cured gel coats are rather soft materials of overall low chemical resistance and limited outdoor durability. The art has a need for a more durable gel coat because IPA/NPG gel coats can fade and chalk, even before the molded plastic article is sold.

Other gel coats presently in use include epoxy, urethane, and vinyl ester resins, particularly when greater flexibility and water resistance are desired. However, these materials also tend to fade and lose their gloss quickly, usually require higher curing temperatures, and are much more difficult to use than the commonly available unsaturated polyester products. In addition, these resins are difficult to formulate into gel coat compositions having desirable physical properties, in-mold curing times, and handling properties without the use of more than a nominal amount of styrene or similar volatile monomer as a reactive diluent. Moreover, because these diluents are the subject of numerous federal, state, and local regulations, manufacturers of molded plastic articles prefer to use gel coat compositions that contain minimal styrene or similar volatile monomers.

In particular, vinyl esters formed from the reaction of an aromatic polyepoxide with an unsaturated monocarboxylic acid have excellent hydrolysis resistance. However, the presence of aromatic nuclei and the necessary addition of high levels of unsaturated aromatic monomers to obtain a sprayable viscosity leads to unacceptable exterior durability. Vinyl ester resins based on aliphatic polyepoxides exhibit poor hydrolysis resistance.

### SUMMARY OF THE INVENTION

Present-day gel coat compositions fail to meet the requirements for weatherability, color stability, and hydrolysis resistance for external applications, such as automotive applications. These requirements include no significant loss of gloss, change in color, or build-up of chalky oxidation products on the surface of the cured gel coat.

While not intending to be bound by theory, present-day gel coat compositions fail because of the chemistry used in preparing the base resin incorporated into the gel coat composition. Typically, the chemistry is based on an unsaturated polyester, or a hybrid chemistry based on polyesters and acrylates. The present invention is directed to a new resin for use in a gel coat composition that overcomes problems and disadvantages associated with prior base resins used in gel coat compositions.

The present invention, therefore, is directed to a urethane acrylate resin that exhibits substantially improved performance over present-day base resins used in gel coat compositions. Gel coat compositions containing a present urethane acrylate resin retain a high gloss and consistent color over extended time periods.

The above-described deficiencies in prior gel coat compositions have been overcome by incorporating a urethane acrylate resin of the present invention into a gel coat composition. The improved gel coat compositions provide cured gel coats having excellent weathering and hydrolytic stability.

In particular, the present invention is directed to a urethane acrylate gel coat resin. More particularly, the present invention is directed to a urethane acrylate gel coat resin that is a reaction product of (a) an oligoester of weight average molecular weight (M;) about 200 to about 4000, (b) a diisocyanate, and (c) a hydroxyalkyl (meth)acrylate.

Accordingly, one important aspect of the present invention is to provide a urethane acrylate gel coat resin containing a reaction product of component A (oligoester), component B (diisocyanate), and component C (hydroxyalkyl (meth)acrylate), and having an idealized structure (I):
C-B-A-B-C. (I)
Notably, the reaction product of components A, B, and C also contains other species in addition to idealized structure (I) and this invention is not limited to idealized structure (I).

Another aspect of the present invention is to provide a urethane acrylate gel coat resin for incorporation into a gel coat composition. The gel coat composition provides a cured gel coat having improved weatherability, including gloss retention and color stability.

Still another aspect of the present invention is to provide a urethane acrylate gel coat resin having terminal acrylate groups. The terminal acrylate groups can be polymerized, for example, using free radical polymerization techniques to provide a cured gel coat.

Another aspect of the present invention is to provide a urethane acrylate gel coat resin suitable for use in gel coat compositions, wherein the resin is the reaction product of (a) a hydroxy terminated oligoester having M_{w} of about 200 to about 4000, (b) a diisocyanate (preferably predominantly an aliphatic diisocyanate), and (c) a hydroxyalkyl (meth)acrylate, wherein a reaction mixture of (a), (b), and (c) has a molar ratio of about 0.75 to about 1.25 moles of (a), about 1.5 to about 2.5 moles of (b), and about 1.5 to about 2.5 moles of (c). Preferred mole ratios of (a), (b), and (c) are about 0.9 to about 1.1 moles (a), about 1.7 to about 2.5 moles (b), and about 1.7 to about 2.2 moles (c), and especially about 0.95 to about 1.05 moles (a), about 1.7 to about 2 moles (b), and about 1.7 to about 2 moles (c).

These and other aspects and advantages of the present invention will become apparent from the following detailed description of the preferred embodiments.

### DETAILED DESCRIPTION OF THE PREFERRED EMBODIMENTS

The present invention is directed to a urethane acrylate gel coat resin useful as a base resin in gel coat compositions. After curing, a gel coat composition containing a resin of the present invention possesses not only very desirable gloss and gloss retention properties, but also exhibits excellent outdoor durability, hardness, toughness, and good handling properties during the molding process.

A urethane-acrylate gel coat resin of the present invention has an idealized structure (I)
C-B-A-B-C, (I)
wherein (I) is the reaction product of an oligoester having M_{w} of about 200 to about 4,000 (A), a diisocyanate (B), and a hydroxyalkyl (meth)acrylate (C). A urethane acrylate gel coat resin of the present invention is a reaction product of A, B, and C, thus other reactions species generally are present in addition to a resin of idealized structure (I).

In accordance with an important feature of the present invention, a present urethane acrylate gel coat resin contains an oligoester of M_{w} about 200 to about 4000 that is reacted with a diisocyanate, and the resulting urethane product is end-capped with a hydroxyalkyl (meth)acrylate. The urethane acrylate resin therefore contains terminal vinyl groups available for free radical polymerization, typically using a peroxide catalyst.

The individual ingredients used in the manufacture of a present urethane acrylate gel coat resin are described in more detail below.

(a) Oligoester

The oligoester component (A) of a present urethane acrylate gel coat resin preferably has a weight average molecular weight of about 200 to about 4000 and preferably is prepared from one or more saturated polyol and one or more saturated or unsaturated polycarboxylic acid or dicarboxylic acid anhydride. As used herein, the terms “polyol” and “polycarboxylic” are defined as compounds that contain two or more, and typically two to four, hydroxy (OH) groups, or two or more, typically two or three, carboxyl (COOH) groups, respectively. Preferably, the oligoester is hydroxy terminated to provide reactive moieties for a subsequent reaction with a diisocyanate.

The polyesters typically are prepared from an aliphatic dicarboxylic acid or aliphatic dicarboxylic acid anhydride, and an aliphatic polyol. These ingredients are interacted preferably to provide a polyester having M_{w} of about 200 to about 4000, more preferably about 400 to about 3500, and most preferably about 500 to about 3000. Accordingly, the polyesters are low molecular weight oligoesters.

The oligoester typically is prepared, for example, by condensing an aliphatic dicarboxylic acid or aliphatic dicarboxylic acid anhydride with a polyol, preferably a diol. The polyol and dicarboxylic acid or acid anhydride, in correct proportions, are interacted under standard esterification procedures to provide an oligoester having the necessary M_{w}, molecular weight distribution, branching, and hydroxy-terminated functionality for use in a present urethane acrylate gel coat resin. In particular, the relative amounts of dicarboxylic acid and polyol are selected such that a sufficient excess molar amount of the polyol is present in order to provide a hydroxy terminated oligoester.

Nonlimiting examples of diols used to prepare the oligoesters include ethylene glycol, diethylene glycol, trimethylene glycol, propylene glycol, dipropylene glycol, hexylene glycol, 1,3-butylene glycol, 1,4-butylene glycol, neopentyl glycol, cyclohexanedimethanol, pinacol, pentanediol, 2,2-dimethyl-1,3-propanediol, isopropylidene bis(p-phenyleneoxypropanol-2), a polyethylene or polypropylene glycol having a weight average molecular weight of about 500 or less, and mixtures thereof. A small amount of a triol or polyol, e.g., up to 5 mole %, more preferably 0 to 3 mole % of a triol or polyol, can be used to provide a partially branched, as opposed to linear, oligoester. Nonlimiting examples of a triol include glycerol and trimethylolpropane.

Exemplary dicarboxylic acids, and anhydrides thereof, used to prepare a hydroxy-terminated oligoester include aliphatic dicarboxylic acids, such as, but not limited to, adipic acid, malonic acid, cyclohexanedicarboxylic acid, sebacic acid, azeleic acid, succinic acid, glutaric acid, and mixtures thereof. Substituted aliphatic dicarboxylic acids, such as halogen or alkyl-substituted dicarboxylic acids, also are useful.

Additional suitable dicarboxylic acids, and anhydrides thereof, include maleic, dihydroxymaleic, diglycollic, oxalacetic, oxalic, pimelic, suberic, chlorosuccinic, mesoxalic, acetone dicarboxylic, dimethyl malonic,1,2-cyclopropanedicarboxylic, cyclobutane-1,1-dicarboxylic, cyclobutane-1,2-dicarboxylic, cyclobutane-1,3-dicarboxylic, cyclopentane-1,1-dicarboxylic, cyclopentane-1,2-dicarboxylic, 2,5-dimethylcyclopentane-1,1-dicarboxylic, alpha,alpha′-di-sec-butyl-glutaric, beta-methyl-adipic, isopropyl-succinic, and 1,1-dimethyl-succinic acids.

Additional suitable diols, triols, polyols, dicarboxylic acids and anhydrides, and polycarboxylic acids are disclosed in U.S. Pat. No. 5,777,053, incorporated herein by reference.

(b) Diisocyanate

The diisocyanate component (B) of a present urethane acrylate gel coat resin is an aliphatic diisocyanate. The diisocyanate component optionally can contain up to about 20%, and preferably up to about 10%, by total weight of the diisocyanate, of an aromatic diisocyanate. The identity of the aliphatic diisocyanate is not limited, and any commercially available commercial or synthetic diisocyanate can be used in the manufacture of a urethane acrylate gel coat resin of the present invention.

Nonlimiting examples of aliphatic diisocyanates include 1,6-hexamethylene diisocyanate, isophorone diisocyanate, 1,4-cyclohexane diisocyanate, 2,4′-dicyclohexylmethane diisocyanate, 4,4′-dicyclohexylmethane diisocyanate, 1,3-bis(isocyanatomethyl)cyclohexane, 1,4-bis((isocyanatemethyl)cyclohexane, tetramethylxylylene diisocyanate, 1,11-diisocyanatoundecane, 1,12-diisocyanatododecane, 2,2,4-trimethyl-1,6-diisocyanatohexane, 2,4,4-trimethyl-1,6-diisocyanatohexane, 1,2-bis(isocyanatomethyl)cyclobutane, hexahydro-2,4-diisocyanatotoluene, hexhydro-2,6-diisocyanatotoluene, 1-isocyanato-2-isocyanatomethyl cyclopentane, 1-isocyanato-3-isocyanatomethyl-3,5,5-trimethyl cyclohexane, 1-isocyanato-4-isocyanatomethyl-1-methyl cyclohexane, 1-isocyanato-3-isocyanatomethyl-1-methyl cyclohexane, and mixtures thereof. A preferred aliphatic diisocyanate is isophorone diisocyanate.

Nonlimiting examples of optional aromatic diisocyanates includes toluene 2,4-diisocyanate, toluene 2,6-diisocyanate, 4,4′-methylene diphenyl diisocyanate, 2,4′-methylene diphenyl diisocyanate, polymeric methylene diphenyl diisocyanate, p-phenylene diisocyanate, naphthalene-1,5-diisocyanate, and mixtures thereof.

Additional aliphatic and aromatic diisocyanates are disclosed in U.S. Pat. No. 5,777,053, incorporated herein by reference.

(c) Hydroxyalkyl (meth)acrylate)

The hydroxyalkyl (meth)acrylate component (C) of a present urethane acrylate gel coat resin is preferably a hydroxyalkyl ester of an α, β-unsaturated acid, or anhydride thereof. Suitable α, β-unsaturated acids include a monocarboxylic acid such as, but not limited to, acrylic acid, methacrylic acid, ethacrylic acid, α-chloroacrylic acid, α-cyanoacrylic acid, β-methylacrylic acid (crotonic acid), α-phenylacrylic acid, β-acryloxypropionic acid, cinnamic acid, p-chlorocinnamic acid, β-stearylacrylc acid, and mixtures thereof. As used throughout this specification, the term “(meth)acrylate” is an abbreviation for acrylate and/or methacrylate.

A preferred acrylate monomer containing a hydroxy group is a hydroxyalkyl (meth)acrylate having the following structure: 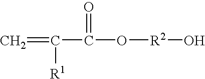
wherein R¹ is hydrogen or methyl, and R² is a C₁ to C₆ alkylene group or an arylene group. For example, R² can be, but is not limited to (—CH₂—)ₙ, wherein n is 1 to 6, 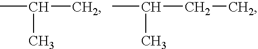
any other structural isomer of an alkylene group containing three to six carbon atoms, or can be a cyclic C₃-C₆ alkylene group. R² also can be an arylene group like phenylene (i.e., C₆H₄) or naphthylene (i.e., C₁₀H₆). R² optionally can be substituted with relatively nonreactive substituents, like C₁-C₆ alkyl, halo (i.e., Cl, Br, F, and I), phenyl, alkoxy, and aryloxy (i.e., an OR² substituent).

Specific examples of monomers containing a hydroxy group are the hydroxy (C₁-C₆) alkyl (meth)acrylates, e.g., 2-hydroxyethyl methacrylate, 2-hydroxyethyl acrylate, 2-hydroxypropyl methacrylate, and 3-hydroxypropyl methacrylate.

The relative amounts of (a), (b), and (c) used in the manufacture of a urethane acrylate gel coat resin of the present invention are sufficient to provide a reaction product having an idealized structure (I). Accordingly, component (a) is used in a molar amount of about 0.75 to about 1.25, and preferably about 0.9 to 1.1 moles; component (b) is used in an amount of 1.5 to about 2.5, and preferably about 1.7.to about 2.2 moles; and component (c) is used in an amount of about 1.5 to about 2.5, and preferably about 1.7 to about 2.2 moles. To achieve the full advantage of the present invention, the mole ratio of (a):(b):(c) is 1:1.7-2:1.75-2.

A urethane acrylate gel coat resin of the present invention is manufactured by first preparing the oligoester. The oligoester is prepared from a polyol, predominantly or completely a diol, and a polycarboxylic acid, predominantly or completely a dicarboxylic acid or anhydride thereof, using standard esterifying condensation conditions. The amounts and relative amounts of polyol and polycarboxylic acid are selected, and reaction conditions are used, such that the oligoester preferably has an M_{w} of about 200 to about 4000 and is hydroxy terminated. The oligoester can be saturated or unsaturated.

The oligoester then is blended with the hydroxyalkyl (meth)acrylate, followed by addition of the diisocyanate. The resulting reaction leads to a mixture of products, including a species having the idealized structure (I). Structure (I) has terminal acrylate moieties available for polymerization using standard free radical techniques, e.g., using initiators such as peroxides or peroxy esters.

To demonstrate the usefulness of a urethane acrylate gel coat resin of the present invention, the following examples were prepared. These resins can be incorporated into a gel coat composition, which, after curing, exhibits excellent weatherability and color stability.

The following abbreviations are used in the Examples:

| | |
|---|---|
| NPG | neopentyl glycol |
| MA | maleic anhydride |
| DBTDL | Dibutyl tin dilaurate |
| HEA | 2-hydroxyethyl acrylate |
| IPDI | isophorone diisocyanate |
| MMA | methyl methacrylate |
| THQ | toluhydroquinone |
| TMP | trimethyolpropane |
| HALS | hindered amine light stabilizer |
| BYK-A-555 | silicone defoamer, commercially available |
| | from BYK-Chemie USA, Inc. |
| AEROSIL 200 | fumed silica, commercially available from |
| | Degussa Corporation |
| SARTOMER SR-9021 | |
| SARTOMER SR-206 | |
| DMMA | dimethyl acetoacetamide |
| TINUVAN 928 | 2-(2H-benzotriazol-2-yl)-6-(1-methyl-1- |
| | phenylethyl-4-(1,1,3,3-tetramethylbutyl)- |
| | phenol, commercially available from Ciba |
| | Specialty Chemicals Corporation |
| TINUVAN 123 | bis-(1-octyloxy-2,2,6-tetramethyl-4- |
| | piperidyl) sebacate, a commercially |
| | available HALS from Ciba Specialty |
| | Chemicals Corporation |

### EXAMPLE 1

NPG (101.64 wt. parts), MA (60.59 wt. parts), and DBTDL (0.42 wt. parts) were added into a flask equipped with a packed column and agitator. The resulting mixture was heated to a maximum of 440° F. and reacted to an acid number of about 5-10 under a nitrogen atmosphere by removing water (11.14 wt. parts). To the resulting oligoester (151.65 wt. parts) was added 2,6-di-t-butyl-p-cresol (0.65 wt. parts) and HEA (75.71 wt. parts) at 200° F. IPDI (114.28 wt. parts) was added to the resulting mixture via an addition funnel to maintain the exothermic reaction temperature below 200° F. The reaction was maintained at 200° F. for one hour followed by the addition of MMA (107.69 wt. parts) as a solvent and THQ (0.03 wt. parts) as an inhibitor. The resulting product was 80%, by weight, urethane acrylate gel coat resin in 20%, by weight, MMA solvent.

### EXAMPLE 2

The urethane acrylate gel coat resin of this example contains a saturated digester. As in Example 1, the oligoester is reacted with IPDI and HEA to produce a urethane polyester copolymer having acrylic unsaturation at the terminal positions. The resin of Example 2 is prepared in a manner essentially identical to Example 1.

| Ingredient | Moles | Wt. Parts |
|---|---|---|
| 1. 1,6-Hexanediol | 2.69 | 24.76 |
| 2. TMP | 0.07 | 0.68 |
| 3. Adipic acid | 2 | 22.66 |

Ingredients 1-3 were reacted under esterifying conditions to remove 5.78 wt. parts of water, and provide an oligoester (40.78 wt. parts) of equivalent weight 239.1. The following ingredients were added to the oligoester, and reacted to form a urethane acrylate gel coat resin of the present invention.

| Ingredient | Moles | Wt. Parts |
|---|---|---|
| 4. DBTDL | | 0.08 |
| 5. 2,6-di-t-butyl-p-cresol | | 0.13 |
| 6. HEA | 2.11 | 13.92 |
| 7. IPDI | 4 | 25.30 |
| 8. THQ | | 0.006 |
| 9. MMA | | 19.79 |

### EXAMPLE 3

1,6-Hexanediol (94.8 wt. parts) and TMP (2.6 wt. parts) were added into a flask equipped with an agitator, and the mixture was melted. Next, adipic acid (86.8 wt. parts) was added, and the resulting mixture was heated to 440° F., under a nitrogen atmosphere. An esterification reaction was performed, at a maximum temperature of 460° F., until the acid number was less than 10, preferably less than 7. Water (21.1 wt. parts) was removed during the reaction. The resulting oligoester was cooled to 140° F. using a one part air sparge and 2 part nitrogen blanket. Next, DBTDL (0.31 wt. parts), 2.6-di-t-butyl-p-cresol (0.53 wt. parts), HEA (55.7 wt. parts), and IPDI (101.2 wt. parts) were added to the oligoester. The IPDI was added at a rate such that the exothermic reaction was maintained below 200° F. (e.g., over about 30-60 minutes). The reaction was continued for 2 to 3 hours, periodically testing for free isocyanate groups (% NCO). A % NCO of less than 0.3 is preferred. At the completion of the reaction, THQ (0.03 wt. parts) and MMA (79.2 wt. parts) were added slowly to the urethane acrylate gel coat resin at a temperature below 190° F. The resulting mixture was stirred at 140° F. for at least one hour. The resulting product contained 80% urethane acrylate gel coat resin and 20% MMA solvent.

The urethane acrylate gel coat resins of the present invention can be used in gel coat compositions. A resin of the present invention is the base resin of the gel coat composition, and can be formulated with other standard gel coat composition ingredients. The urethane acrylate gel coat resin can be cured by polymerization of the terminal acrylate groups using standard free radical techniques.

In particular, gel coat compositions can be formulated using the resins of this invention in the usual method. Gel coat compositions include pigments, extenders, promoters, catalysts, stabilizers, and the like as practiced in the art. Such, gel compositions typically comprise about 25 to about 50 weight percent urethane acrylate gel coat resin, and about 10 to about 50 weight percent styrene or other vinyl monomer, said percentages being based on combined weights of resin and vinyl monomer. Other gel coat composition-ingredients include acrylic diluents (e.g., MMA), additives (e.g., silica, cobalt salts, silicone release agent, hydroxyalkyl (meth)acrylates, dimethyl acetoacetomide), a pigment paste, a free radical initiator (e.g., methyl ethyl ketone peroxide), UV stabilizers, thixotropes, and other resins (e.g., an isophthatic-NPG-maleic unsaturated polyester).

The preparation of a gel coat composition, and curing of a gel coat composition to provide a gel coat for an article of manufacture are generally disclosed in WO 94/07674 and U.S. Pat. No. 4,742,121, incorporated herein by reference. Gel coat compositions incorporating a urethane acrylate gel coat resin of the present invention are disclosed in Kia et al. U.S. provisional application entitled “Gel Coat Composition,” filed on Aug. 9, 2002 (GM Ref. No. GP-301493, HD&P Ref. No. 8540R-000005), incorporated herein by reference.

EXAMPLE 4
General Dark Color Gel Coat Formula

| | wt. % |
|---|---|
| Urethane acrylate gel coat resin | 38-50 |
| (80% in MMA) | |
| Styrene | 0-5 |
| Air release agent | .1-1 |
| Thixotrope | .5-3 |
| Reactive monomer | 20-35 |
| Cobalt | .1-.5 |
| Cobalt promoter | .2-.7 |
| UV inhibitor | .2-.5 |
| HALS | .2-1 |
| Glycol synergist | .1-1.5 |
| Pigment paste | 10-25 |

Fillers (e.g., mica, aluminum trihydrate, barium sulfate, and the like) are optional ingredients present at 0-15 wt. %. Blocked isocyanates are also optional ingredients present at 0-20 wt. %.

Examples of reactive monomers include, but are not limited to, methyl methacrylate (10-20 wt. %), ethylene glycol dimethacrylate, e.g., SARTOMER SR-206 (1-10 wt. %), highly propoxylated glyceryl triacrylate, e.g., SARTOMER SR-9021 (0-10 wt. %), and mixtures thereof.

The pigment paste contains a pigment in an unsaturated polyester carrier resin. The paste also contains wetting agents, dispersing agents, and inhibitors, in minor amounts. Saturated polyesters also can be used as the carrier resin. The carrier resin also can be different from a polyester, e.g., a urethane diacrylate, an acrylic silicone, or similar resin. The pigment paste is prepared by adding the pigment and other ingredients to the carrier resin, then mixing in a grinding machine.

EXAMPLE 5
Blue Gelcoat Composition

| Ingredient | Weight (kg) |
|---|---|
| Urethane acrylate gel coat resin of Example 2 | 42 |
| Styrene monomer | 4 |
| BYK-A 555 | 1 |
| AEROSIL 200 | 2 |
| Grind to 6 on Hegmann gauge | |
| SARTOMER SR 9021 | 10 |
| SARTOMER SR-206 | 1 |
| Methyl methacrylate | 19 |
| Cobalt octoate (12%) in mineral spirits and | 0.5 |
| dipropylene glycol monomethyl ether | |
| DMAA | 0.1 |
| | (gram) |
| TINUVIN 928 | .5 |
| TINUVIN 123 | 1 |
| 2-hydroxyethyl methacrylate | 1 |
| Blend 10 minutes | |
| Blue tinter | 17 |
| White tinter | 1 |

EXAMPLE 6
White Gelcoat Composition

| Ingredient | Weight (kg) |
|---|---|
| Urethane acrylate gel coat resin of Example 2 | 24.6149 |
| Styrene monomer | 4 |
| BYK-A 555 | 1 |
| AEROSIL 200 | .5 |
| Grind to 6 on Hegmann Gauge | |
| SARTOMER SR-9021 | 7 |
| SARTOMER SR-206 | 1 |
| Methyl methacrylate | 17.175 |
| Cobalt octoate (12%) in mineral spirits and | .2 |
| dipropylene glycol monomethyl ether | |
| DMAA | .1 |
| | gram |
| TINUVIN 928 | .5 |
| TINUVIN 123 | 1 |
| 2-Hydroxyethyl methacrylate | 1 |
| Blend 10 minutes | |
| Blue tinter | .01 |
| White tinter | 42 |

A gel coat composition comprising a urethane acrylate gel coat resin of the present invention after curing, exhibits excellent weatherability and color stability. The urethane acrylate gel coat resin also is readily formulated into gel coat composition. Furthermore, incorporation of a urethane acrylate gel coat resin of the present invention into a gel coat composition permits a significant reduction in the amount of other resins, such as unsaturated polyesters, that typically are included in the gel coat composition. The elimination or reduction of unsaturated polyesters helps improve the weatherability and color stability of cured gel coats.

The above-described advantages of a present urethane acrylate gel coat resin provide an improved gel coat composition useful for application as an exterior of a molded article, for example, an automobile part, an appliance, a bathtub, a shower stall, and similar, reinforced plastic articles of manufacture. A urethane acrylate gel coat resin of the present invention can be used in a variety of gel coat compositions, and, therefore, has a wide range of applications. The enhanced performance characteristics of a gel coat composition comprising a present urethane acrylate gel coat resin is achieved by a novel combination of ingredients utilized to manufacture the urethane acrylate gel coat resin.

Obviously, many modifications and variations of the invention as hereinbefore set forth can be made without departing from the spirit and scope thereof, and, therefore, only such limitations should be imposed as are indicated by the appended claims.

What is claimed is:

1. A urethane acrylate gel coat resin comprising reaction products of a reaction mixture comprising
(a) a hydroxy-terminated oligoester having weight average molecular weight of about 200 to about 4000;
(b) a diisocyanate; and
(c) a hydroxyalkyl (meth)acrylate.

2. The gel coat resin of claim 1 comprising a compound having an idealized structure
C-B-A-B-C,
wherein A is the oligoester, B is the diisocyanate, and C is the hydroxyalkyl (meth)acrylate.

3. The resin of claim 1 wherein the oligoester is saturated or unsaturated and has a weight average molecular weight of about 500 to about 3000.

4. The gel coat resin of claim 1 wherein the oligoester is a reaction product of (a) a saturated diol and an optional saturated triol, and (b) a saturated or an unsaturated dicarboxylic acid, a saturated or unsaturated dicarboxylic acid anhydride, or mixtures thereof.

5. The gel coat resin of claim 4 wherein the diol and triol are selected from the group consisting of 1,6-hexanediol, neopentyl glycol, trimethylolpropane, 1,3-butylene glycol, 1,4-butylene glycol, cyclohexanedimethanol, ethylene glycol, propylene glycol, pinacol, pentanediol, 2,2-dimethyl-1,3-propanediol, isopropylidene bis(p-phenyleneoxypropanol-2), a polyethylene or polypropylene glycol having a weight average molecular weight of about 500 or less, and mixtures thereof.

6. The gel coat resin of claim 5 wherein the dicarboxylic acid is selected from the group consisting of adipic acid, maleic acid, malonic acid, cyclohexanedicarboxylic acid, sebacic acid, azelaic acid, succinic acid, glutaric acid, pimelic acid, suberic acid, chlorosuccinic acid, maleic acid, dihydroxymaleic acid, diglycollic acid, oxalacetic acid, oxalic acid, pimelic acid, suberic acid, chlorosuccinic acid, mesoxalic acid, acetone dicarboxylic acid, dimethyl malonic acid, 1,2-cyclopropanedicarboxylic acid, cyclobutane-1,1-dicarboxylic acid, cyclobutane-1,2-dicarboxylic acid, cyclobutane-1,3-dicarboxylic acid, cyclopentane-1,1-di-carboxylic acid, cyclopentane-1,2-dicarboxylic acid, 2,5-dimethylcyclopentane-1,1-dicarboxylic acid, alpha,alpha′-di-sec-butylglutaric acid, beta-methyl-adipic acid, isopropyl-succinic acid, and 1,1-di-methyl-succinic acid, anhydrides thereof, and mixtures thereof.

7. The gel coat resin of claim 1 wherein a reaction mixture of (a), (b), and (c) contains a molar ratio of about 0.75 to about 1.25 mole (a) to about 1.5 to about 2.5 moles (b) to about 1.5 to about 2.5 moles (c).

8. The gel coat resin of claim 1 wherein the diisocyanate comprises (a) an aliphatic diiscyanate and (b) up to 20% of an aromatic diisocy by total weight of the diisocyanate.

9. The gel coat resin of claim 8 wherein the aliphatic diisocyanate is selected from the group consisting of 1,6-hexamethylene diisocyanate, isophorone diisocyanate, 1,4-cyclohexane diisocyanate, 2,4′-dicyclohexylmethane diisocyanate, 4,4′-dicyclohexylmethane diisocyanate, 1,3-bis(isocyanatomethyl)cyclohexane, 1,4-bis(isocyanatomethyl)cyclohexane, tetramethylxylylene diisocyanate, 1,11-diisocyanatoundecane, 1,12-diisocyanatododecane, 2,2,4-trimethyl-1,6-diisocyanatohexane, 2,4,4-trimethyl-1,6-diisocyanatohexane, 1,2-bis-(isocyanatomethyl)cyclobutane, hexahydro-2,4-diisocyanatotoluene, hexhydro-2,6-diisocyanatotoluene, 1-isocyanato-2-isocyanatomethyl cyclopentane, 1-isocyanato-3-isocyanatomethyl-3,5,5-trimethyl cyclohexane, 1-isocyanato-4-isocyanatomethyl1-1-methyl cyclohexane, 1-isocyanato-3-isocyanatomethyl-1-methyl cyclohexane, and mixtures thereof.

10. The gel coat resin of claim 9 comprising 0% to about 20%, by total weight of the diisocyanate, of an aromatic diisocyanate selected from the group consisting of toluene 2,4-diisocyanate, toluene 2,6-diisocyanate, 4,4′-methylene-diphenyl diisocyanate, 2,4′-methylene diphenyl diisocyanate, polymeric methylene diphenyl diisocyanate, p-phenylene diisocyanate, naphthalene-1,5-diisocyanate, and mixtures thereof.

11. The gel coat resin of claim 1 wherein the hydroxyalkyl (methyl)acrylate has a structure 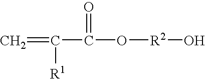
wherein R¹ is hydrogen or methyl and R² is a C₁ to C₆ alkylene group or an arylene group.

12. The gel coat resin of claim 1 wherein the hydroxyalkyl (meth)acrylate is selected from the group consisting of 2-hydroxylethyl methacrylate, 2-hydroxyethyl acrylate, 2-hydroxypropyl methacrylate, 3 -hydroxypropyl methacrylate, and mixtures thereof.

13. The gel coat resin of claim 1 wherein the oligoester comprises a reaction of product of (a) neopentyl glycol, 1,6-hexanediol, or a mixture thereof and (b) adipic acid.

14. The gel coat resin of claim 13 wherein the diisocyanate comprises isophorone diisocyanate.

15. The gel coat resin of claim 14 wherein the hydroxyalkyl (meth)acrylate comprises 2-hydroxyethyl acrylate.

16. A gel coat composition comprising a urethane acrylate gel coat resin of claim 1.

17. The gel coal at composition of claim 16 wherein the gel coat resin is present in the composition in an amount of about 25% to about 50%, by weight, of the composition.

18. The gel coat composition of claim 16 further comprising a pigment paste, a free radical initiator, or a mixture thereof.

19. A gel coat prepared by curing a gel coat composition comprising a urethane acrylate gel coat resin of claim 1.

20. The gel coat of claim 19 wherein the gel coat is prepared by a free radical polymerization.

21. An article of manufacture having an exterior gel coat prepared by curing a gel coat composition comprising a urethane acrylate gel coat resin of claim 1.

22. A method of preparing a urethane acrylate gel coat resin comprising the steps of
(a) preparing a hydroxy-terminated oligoester having a weight average molecular weight of about 200 to about 4000 by reacting, (i) a saturated diol and optional saturated triol with (ii) a saturated or unsaturated dicarboxylic acid, a saturated or unsaturated dicarboxylic acid anhydride, or a mixture thereof, in sufficient relative amounts of (i) and (ii) to provide terminal hydroxy groups;
(b) adding a hydroxyalkyl (meth)acrylate to the oligoester of step (a) to form a prereaction mixture;
(c) then adding a diisocyanate to the prereaction mixture of step (b) to form a reaction mixture; and
(d) maintaining the reaction mixture of step (c) at a sufficient temperature for a sufficient time to react essentially all isocyanate moieties of the diisocyanate and yield the urethane acrylate gel coat resin.

23. The method of claim 22 wherein the gel coat resin has an acrylate group positioned at each terminal end of the resin.

24. The method of claim 23 wherein the gel coat resin is prepared using a molar ratio of (I) oligoester to (II) diisocyanate to (III) hydroxyalkyl (meth)acrylate of about 0.9 to about 1.1 (I) to about 1.5 to about 2.2 (II) to about 1.5 to about 2.2 (III).

25. The method of claim 23 wherein the gel coat resin is prepared using a mole ratio of oligoester to diisocyanate to hydroxyalkyl (meth)acrylate of 1:1.7-2:1.7-2, respectively.
